(19) United States
(12) Patent Application Publication
(10) Pub. No.: US 2018/0311735 A1
(43) Pub. Date: Nov. 1, 2018

(54) MANUFACTURING METHOD AND MANUFACTURING APPARATUS FOR ADDITIVELY SHAPED ARTICLE

(71) Applicant: JTEKT CORPORATION, Osaka-shi (JP)

(72) Inventors: Tetsuya Mitsui, Kariya-shi (JP); Yoshinori Imoto, Kariya-shi (JP); Takaya Nagahama, Obu-shi (JP); Koichi Shiiba, Nisshin-shi (JP); Makoto Tano, Obu-shi (JP)

(73) Assignee: JTEKT CORPORATION, Osaka-shi (JP)

(21) Appl. No.: 15/959,385

(22) Filed: Apr. 23, 2018

(30) Foreign Application Priority Data
Apr. 26, 2017 (JP) 2017-087456

(51) Int. Cl. B22F 3/105

(52) U.S. Cl. CPC B22F 3/1055; B22F 2207/13; B33Y 10/00; B22F 2301/052; B22F 2304/00; B22F 2301/10

(57) ABSTRACT

An additively shaped article manufacturing method includes: a first step of feeding a plurality of base material particles and a plurality of microparticles both constituting metal powder to an irradiation area of a shaping optical beam; and a second step of applying the shaping optical beam to the microparticles and respective irradiated surfaces that are respective surfaces of the base material particles on a side to be irradiated with the shaping optical beam. The microparticles are formed of a metal identical in type to the base material particles and have an average volume smaller than the average volume of the base material particles. The microparticles fed to the irradiation area at the first step are arranged to be in contact with the respective irradiated surfaces of the base material particles.

### INCORPORATION BY REFERENCE

The disclosure of Japanese Patent Application No. 2017-087456 filed on Apr. 26, 2017 including the specification, drawings and abstract, is incorporated herein by reference in its entirety.

### BACKGROUND OF THE INVENTION

### 1. Field of the Invention

The present invention relates to a manufacturing method and a manufacturing apparatus for an additively shaped article.

### 2. Description of Related Art

Recently, development of metal additive manufacturing (AM) has been active that involves sintering or melting powdery metal through laser beam irradiation and then solidifying the sintered or melted metal, and stacking the solidified layers one after another to manufacture a three-dimensionally shaped article. Examples of the metal used for the metal AM include maraging steel, stainless steel, titanium steel, copper, and aluminum.

However, in order to increase strengths of completed additively shaped articles, there is a market demand for a further increase in the absorptance of a laser beam in various metals, thereby quickly melting and solidifying metal powder to stably increase relative densities of the additively shaped articles. In response to this demand, for example, Japanese Patent Application Publication No. 2011-21218 (JP 2011-21218 A) discloses a technique of increasing absorptance by adding a laser absorbent having a high absorptance for a laser beam of a near-infrared wavelength to aluminum powder having an absorptance that is considered to be low especially for a laser beam of a near-infrared wavelength. Consequently, when a laser beam of a near-infrared wavelength is applied, the laser absorbent is first heated by absorbing the laser beam of a near-infrared wavelength, and then the heat is transmitted to the aluminum powder to heat and maintain the heat of the aluminum powder. Under this condition, the aluminum powder is further heated and melted by irradiation with the laser beam of a near-infrared wavelength and by heat from the laser absorbent.

However, in the technique of JP 2011-21218 A, the laser absorbent that is combined with the aluminum powder may act as impurities, thereby adversely affecting the strength or other properties of a product.

### SUMMARY OF THE INVENTION

One object of the present invention is to provide a manufacturing method and a manufacturing apparatus for an additively shaped article, which enable production of an additively shaped article having high relative density and high strength.

An additively shaped article manufacturing method according to one aspect of the present invention is an additively shaped article manufacturing method of additively shaping an article by melting metal powder through irradiation with a shaping optical beam and then solidifying the melted metal powder. The manufacturing method includes: a first step of feeding a plurality of base material particles and a plurality of microparticles both constituting the metal powder to an irradiation area of the shaping optical beam, the microparticles formed of a metal identical in type to the base material particles and having an average volume smaller than the average volume of the base material particles; and a second step of applying the shaping optical beam to the microparticles fed to the irradiation area at the first step and respective irradiated surfaces that are respective surfaces on a side to be irradiated with the shaping optical beam among respective surfaces of the base material particles fed to the irradiation area at the first step. The microparticles fed to the irradiation area at the first step are arranged so as to be in contact with the respective irradiated surfaces of the base material particles.

As described above, in the additively shaped article manufacturing method, at the first step, the microparticles having an average volume smaller than that of the base material particles are fed to the irradiation area so as to be arranged to be in contact with the irradiated surfaces of the base material particles. At the second step, when the shaping optical beam is applied to the microparticles, the temperature of the respective microparticles having a smaller heat capacity because of the smaller average volume rises faster than the temperature rising speed of the base material particles having a larger average volume when the shaping optical beam is applied to the base material particles, and accordingly the microparticles are quickly melted into a liquid state.

Thus, the absorptance of the shaping optical beam in the melted microparticles becomes higher than when the microparticles are in a solid state, and the temperature thereof rises at a more favorable speed. At this time, the melted microparticles the temperature of which has risen heat and maintain the heat of the base material particles that are in contact with the microparticles at the irradiated surfaces, thereby increasing the absorptance of the shaping optical beam in the base material particles. Thus, when the shaping optical beam is applied to the base material particles directly or via the melted microparticles, the shaping optical beam is favorably absorbed by the base material particles, whereby the base material particles can be melted in a short period of time. By this method, an additively shaped article having high relative density and high strength can be stably manufactured.

An additively shaped article manufacturing apparatus according to another aspect of the present invention is an additively shaped article manufacturing apparatus that additively shapes an article by melting metal powder through irradiation with a shaping optical beam and then solidifying the melted metal powder. The manufacturing apparatus includes: a chamber capable of isolating inside air from outside air; a storage that stores a plurality of base material particles and a plurality of microparticles both constituting the metal powder, the microparticles formed of a metal identical in type to the base material particles and having an average volume smaller than the average volume of the base material particles; a metal-powder feeding device that is provided inside the chamber and feeds the base material particles and the microparticles stored in the storage to an irradiation area of the shaping optical beam; and a shaping-optical-beam irradiation device that applies the shaping optical beam to the microparticles and respective irradiated surfaces that are respective surfaces on a side to be irradiated with the shaping optical beam among respective surfaces of the base material particles fed to the irradiation area. In the irradiation area, the microparticles are arranged so as to be in contact with the respective irradiated surfaces of the base material particles. With this configuration, an additively shaped article having high relative density and high strength can be stably manufactured.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a graph illustrating a relation between the wavelength and absorptance of a near-infrared laser beam for each metal material;

FIG. 2 is a graph illustrating a relation between particle diameter of microparticles and a period of time until base material particles melt;

FIG. 3 is a schematic diagram of a manufacturing apparatus according to a first embodiment;

FIG. 4 is a top view of a metal-powder feeding device in FIG. 3;

FIG. 5 is a diagram for explaining a thin film layer;

FIG. 6 is a flowchart of a manufacturing method according to the first embodiment;

FIG. 7 is a diagram for explaining a base-material-particle layer in the thin film layer;

FIG. 8 is an explanatory diagram of a state in which a near-infrared laser beam is applied to microparticles in the thin film layer; and

FIG. 9 is an explanatory diagram of a state in which a near-infrared laser beam is applied to irradiated surfaces in the base-material-particle layer.

### DETAILED DESCRIPTION OF EMBODIMENTS

An outline of an additively shaped article manufacturing apparatus according to a first embodiment of the present invention will be described first. The additively shaped article manufacturing apparatus is a manufacturing apparatus that additively shapes an additively shaped article by melting, through irradiation with a shaping optical beam, metal powder fed to an irradiation area and then solidifying the melted metal powder.

In the present embodiment, as the shaping optical beam, a laser beam of a near-infrared wavelength that is inexpensive is used. Hereinafter, the laser beam of a near-infrared wavelength is called a near-infrared laser beam L1. However, the present invention is not limited to this. The near-infrared laser beam L1 is merely one example, and as the shaping optical beam, not only the laser beam of a near-infrared wavelength (near-infrared laser beam L1), but also a CO₂ laser (infrared laser beam) or a semiconductor laser may be used.

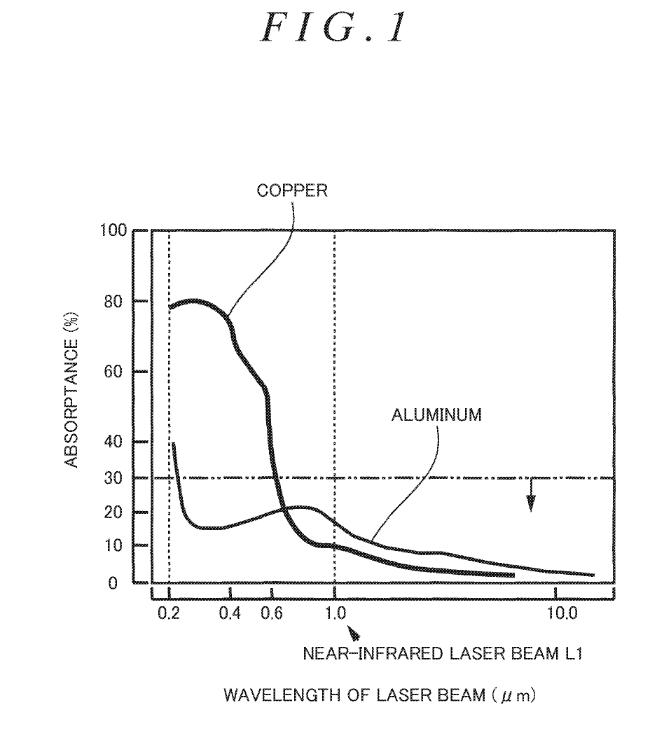

As a metal powder that is a raw material of an additively shaped article, copper powder that is highly demanded in the market is used as one example among various metal materials that can be used. Copper is a low-absorptance material that has an absorptance equal to or lower than a predetermined value for the near-infrared laser beam L1 at room temperature. The expression “equal to or lower than a predetermined value” herein means being equal to or lower than 30%, for example. As depicted in FIG. 1, the absorptance of the near-infrared laser beam L1 in copper is about 10% (that is, equal to or lower than 30%). As depicted in FIG. 1, examples of the low-absorptance material include aluminum in addition to copper.

In the present embodiment, copper powder having a very low absorptance for the near-infrared laser beam L1 is used as the metal powder. However, when the average particle diameter ϕD of the respective particles of the metal powder is sufficiently large (e.g., 30 μm or larger) and the respective particles constitute an aggregate formed of particles having a single diameter, based on past experiences, it cannot be expected that the metal powder having a low absorptance for the near-infrared laser beam L1 quickly rises in temperature and melts.

In view of this, the inventors of the present invention have focused on a well-known finding that even if the metal powder is copper (powder), a period of time until a plurality of copper particles melt is short when the average particle diameter of the copper particles is smaller than a predetermined value. One reason of this may be that the copper particles having a smaller average particle diameter have a smaller heat capacity, which allows the temperature thereof to be sufficiently raised even if the absorbed amount of the near-infrared laser beam L1 is small. Consequently, even if the copper particles in which the absorbed amount of the near-infrared laser beam L1 is small is used, the temperature thereof can be raised to near the melting point in a relatively short period of time when the average particle diameter ϕD is smaller than the predetermined value.

There is also a well-known finding that the absorptance of the near-infrared laser beam L1 in copper particles in a solid state at room temperature is low, but the absorptance rapidly increases when the copper particles rise in temperature and change into a liquid state. Thus, the copper particles that have changed into a liquid state favorably absorb the near-infrared laser beam L1 to quickly rise in temperature. Thus, copper particles the temperature of which has risen heat and maintain the heat of other copper particles that are in contact therewith, which allows these other copper particles to change into a liquid state in a short period of time. Consequently, copper powder that is an aggregate of copper particles can be melted in series in a short period of time, whereby high density and high strength can be obtained.

However, the cost of manufacturing a large number of fine copper particles having an average particle diameter ϕD that is smaller than the predetermined value is high, which makes it difficult to manufacture and use the fine copper particles in mass production, for example, as raw materials for additive shaping. In view of this, the inventors have decided to bring copper particles (corresponding to microparticles in an embodiment) having a small particle diameter requiring a higher cost into contact with copper particles (corresponding to base material particles in the present embodiment) having a conventional particle diameter (e.g., an average particle diameter of about 30 μm) that can be produced at a low cost to use the microparticles as heating materials or heat reserving materials, thereby shortening the period of time until the copper particles (base material particles) having the conventional particle diameter melt. In other words, in order to prevent cost increase, the inventors have decided to use only a small number of expensive microparticles to heat and maintain the heat of conventional inexpensive copper particles (base material particles), thereby shortening the period of time until the copper particles (base material particles) melt.

Thus, in the present embodiment, metal powder 15 (described in detail later) corresponding to the above-described metal powder includes a plurality of base material particles 15a and a plurality of microparticles 15b. In other words, the metal powder 15 is an aggregate of the base material particles 15a and the microparticles 15b. The base material particles 15a and the microparticles 15b are each formed of the same type of copper.

In the present embodiment, the base material particles 15a and the microparticles 15b are each formed in a spherical shape. To form each particle in a spherical shape, for example, a known gas atomization is used. The gas atomization is a known method, and thus detailed description thereof is omitted.

The base material particles 15a and the microparticles 15b are formed such that the ratio of the average particle diameter ϕD2 of the microparticles 15b each formed in a spherical shape to the average particle diameter ϕD1 of the base material particles 15a each formed in a spherical shape becomes ⅙(=ϕD2/ϕD1) as one example. Herein, the average particle diameter is measured by a known laser diffraction and scattering method.

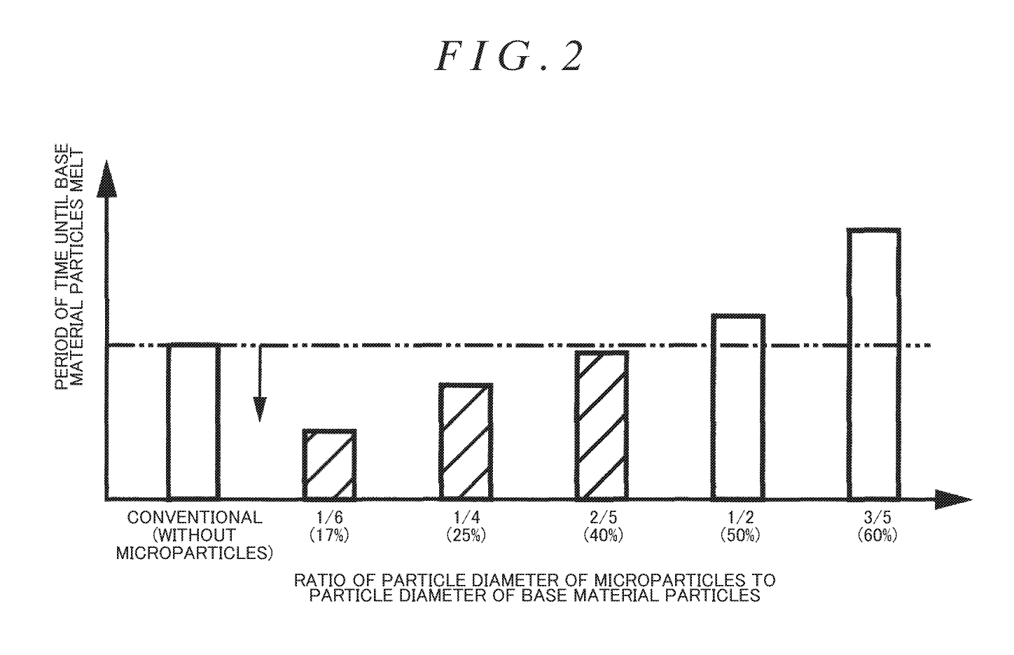

In the foregoing, the ratio (ϕD2/ϕD1) of the average particle diameters ϕD2 of the microparticles 15b to the average particle diameter ϕD1 of the base material particles 15a is set to ⅙. This is a value that is set based on CAE analysis results given in a graph of FIG. 2. The graph of FIG. 2 indicates analysis results of, in a state in which copper particles (base material particles) having a large particle diameter and the copper particles (microparticles) having a small particle diameter are in contact with each other as described above, a period of time until the copper particles (base material particles) having a large particle diameter melt when the laser beam L1 of a near-infrared wavelength is applied to the microparticles. The horizontal axis of the graph represents the ratio of the particle diameter of the microparticles to the particle diameter of the base material particles, and the vertical axis thereof represents a period of time until the base material particles being in contact with the microparticles melt.

From the analysis results, it was found that when the ratio of the particle diameter of the microparticles to the particle diameter of the base material particles is equal to or smaller than ⅖(40%), the period of time until the melting point is reached is shortened in comparison with a conventional method (at the left end in FIG. 2). It was also found that the period of time until the melting point is reached is the shortest when the ratio (ϕD2/ϕD1) is ⅙ among the conditions in FIG. 2.

Based on these results, the ratio (ϕD2/ϕD1) of the average particle diameter ϕD2 of the microparticles 15b to the average particle diameter ϕD1 of the base material particles 15a is set to ⅙. However, the ratio (=ϕD2/ϕD1) of the average particle diameter ϕD2 of the microparticles 15b to the average particle diameter ϕD1 of the base material particles 15a does not have to be ⅙, as long as it is equal to or smaller than ⅖(40%). Within this range, similar effects can be obtained. Based on the conditions described above, the following embodiments will be described.

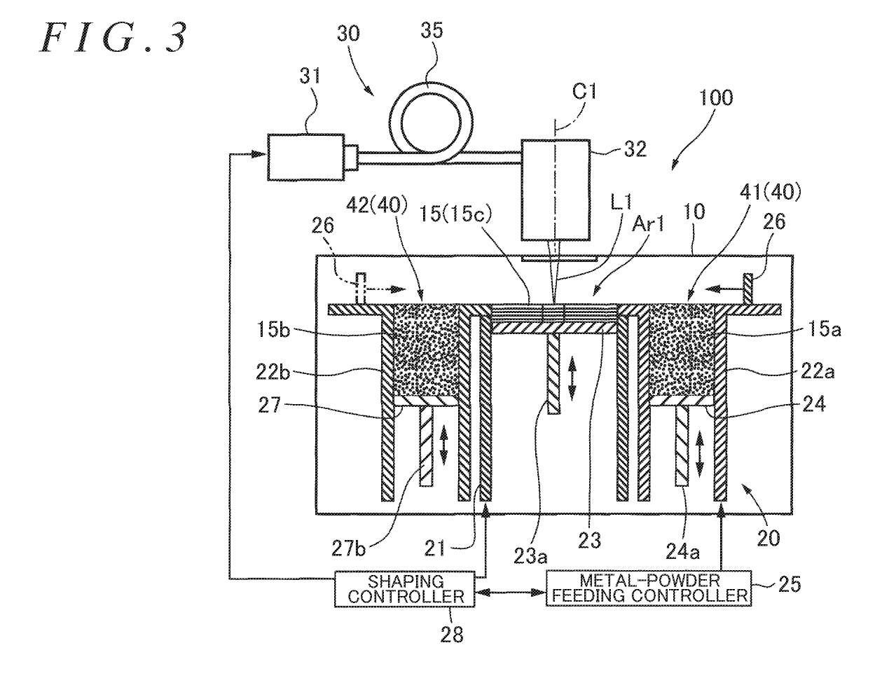

FIG. 3 is a schematic diagram of a manufacturing apparatus 100 according to a first embodiment of the present invention. The manufacturing apparatus 100 includes a chamber 10, a metal-powder feeding device 20, a shaping-optical-beam irradiation device 30, and storages 40. The storages 40 described in detail later include a base-material-particle storage 41 that stores a plurality of base material particles 15a and a microparticle storage 42 that stores a plurality of microparticles 15b.

The chamber 10 is a casing formed in a substantially rectangular parallelepiped shape, and is a container capable of isolating inside air from outside air.

The chamber 10 includes a device (not depicted) that can replace the air inside the chamber with an inert gas such as helium, nitrogen, or argon. Alternatively, the chamber 10 may be configured so that inside of the chamber 10 can be depressurized instead of being replaced with an inert gas.

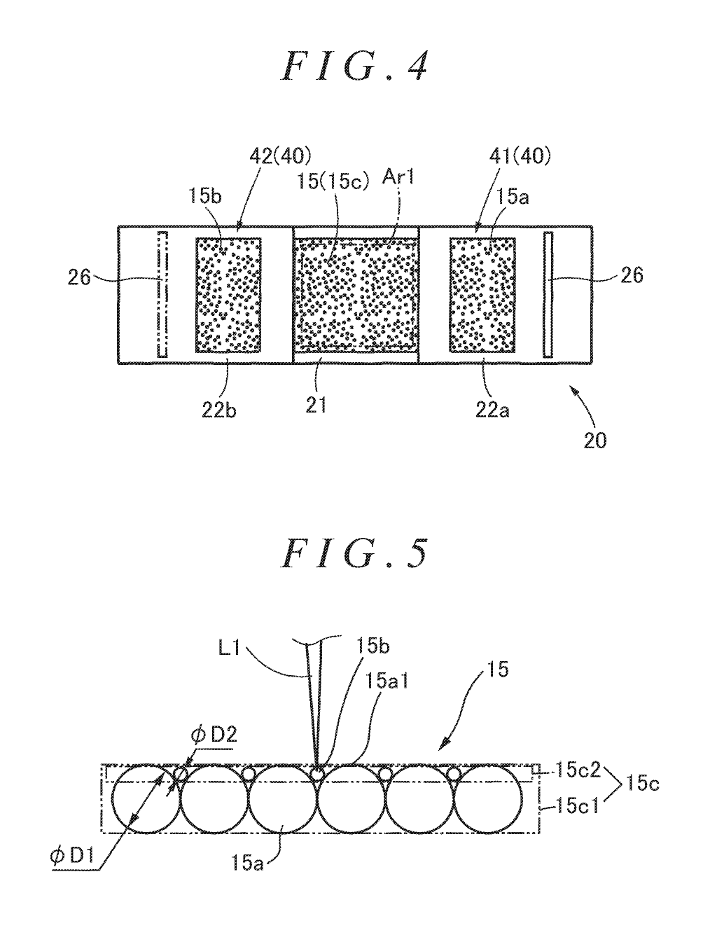

The metal-powder feeding device 20 is provided inside the chamber 10. The metal-powder feeding device 20 is a device that feeds the base material particles 15a and the microparticles 15b described above to an irradiation area Ar1 (see FIG. 4) of the near-infrared laser beam L1 (corresponding to the shaping optical beam). As described above, in the present embodiment, the base material particles 15a and the microparticles 15b fed to the irradiation area Ar1 constitute the metal powder 15.

As depicted in FIG. 3 and FIG. 4, the metal-powder feeding device 20 includes a shaping container 21, a base-material-particle storing container 22a, a microparticle storing container 22b, a shaped-article lifting table 23, a base-material-particle feeding table 24, a microparticle feeding table 27, a metal-powder feeding controller 25 (control unit), a recoater 26, and a shaping controller 28.

As depicted in FIG. 3, inside the shaping container 21, the shaped-article lifting table 23 is provided so as to be movable up and down. On the shaped-article lifting table 23, a thin film layer 15c of the metal powder 15 is formed by the metal-powder feeding device 20. As depicted in FIG. 5, the thin film layer 15c includes, for example, one each of a base-material-particle layer 15c1 containing a plurality of base material particles 15a arranged in a lower region of the thin film layer 15c and a microparticle layer 15c2 containing a plurality of microparticles 15b arranged in an upper region of the base-material-particle layer 15c1. Details will be described later. To the shaped-article lifting table 23, a support shaft 23a is attached. The support shaft 23a is connected to a driving device (not depicted), and is moved up and down by operation of the driving device. The driving device is controlled by the shaping controller 28.

Inside the base-material-particle storing container 22a, the base-material-particle feeding table 24 is provided so as to be movable up and down. On the base-material-particle feeding table 24, a plurality of base material particles 15a (aggregate) yet to be fed to the irradiation area Ar1 are stored. By moving the base-material-particle feeding table 24 upward, a plurality of base material particles 15a to be fed to the irradiation area Ar1 are caused to protrude from an opening at the top of the base-material-particle storing container 22a.

In this manner, the base-material-particle storing container 22a and the base-material-particle feeding table 24 constitute the base-material-particle storage 41 (storage 40) that stores the base material particles 15a. To the base-material-particle feeding table 24, a support shaft 24a is attached. The support shaft 24a is connected to a driving device (not depicted). The base-material-particle feeding table 24 is moved up and down by operation of the driving device. The driving device is controlled by the metal-powder feeding controller 25.

Inside the microparticle storing container 22b, the microparticle feeding table 27 is provided so as to be movable up and down. On the microparticle feeding table 27, a plurality of microparticles 15b (aggregate) yet to be fed to the irradiation area Ar1 are stored. By moving the microparticle feeding table 27 upward, a plurality of microparticles 15b to be fed to the irradiation area Ar1 are caused to protrude from an opening at the top of the microparticle storing container 22b.

In this manner, the microparticle storing container 22b and the microparticle feeding table 27 constitute the microparticle storage 42 that stores the microparticles 15b. To the microparticle feeding table 27, a support shaft 27b is attached. The support shaft 27b is connected to a driving device (not depicted), and the microparticle feeding table 27 is moved up and down by operation of the driving device. The driving device is controlled by the metal-powder feeding controller 25.

The recoater 26 depicted in FIG. 3 is provided so as to be movable in a reciprocating manner across all areas of the respective openings of the base-material-particle storing container 22a, the shaping container 21, and the microparticle storing container 22b in the lateral direction. Herein, the respective upper end surfaces of the base-material-particle storing container 22a, the shaping container 21, and the microparticle storing container 22b are flush with each other. Thus, the recoater 26 is moved in a reciprocating manner between the right side of the base-material-particle storing container 22a and the left side of the microparticle storing container 22b depicted in FIG. 3. The recoater 26 is connected to a driving device (not depicted), and is moved right and left by operation of the driving device. The driving device is controlled by the metal-powder feeding controller 25.

Based on a preset program, the shaping-optical-beam irradiation device 30 applies the near-infrared laser beam L1 to a surface of the thin film layer 15c (the base-material-particle layer 15c1 and the microparticle layer 15c2) of the metal powder 15 (the base material particles 15a and the microparticles 15b ) fed to the irradiation area Ar1 (see FIG. 4) by the metal-powder feeding device 20.

As depicted in FIG. 3, the shaping-optical-beam irradiation device 30 includes a laser oscillator 31, a laser head 32, and a shaping controller 28 that controls operation of each device. The laser oscillator 31 includes an optical fiber 35 for transmitting a near-infrared laser beam L1 caused to oscillate by the laser oscillator 31 to the laser head 32.

The laser oscillator 31 generates the near-infrared laser beam L1, which is a laser beam of a continuous-wave (CW) laser beam, by oscillating such that the wavelength becomes a predetermined near-infrared wavelength set in advance. The wavelength of the near-infrared laser beam L1 is around 1.0 μm. Specifically, as the near-infrared laser beam L1, HoYAG (wavelength: about 1.5 μm), yttrium vanadate (YVO, wavelength: about 1.06 μm), ytterbium (Yb, wavelength: about 1.09 μm), and a fiber laser, for example, can be used.

Thus, the laser oscillator 31 can be produced inexpensively, and can also be operated inexpensively because of its low energy consumption. As depicted in FIG. 1 illustrating a relation between the wavelength (μm) of a laser beam and the absorptance (%) of the laser beam for each material, the absorptance of the near-infrared laser beam L1 in copper and aluminum is relatively low, and the absorptance thereof is not higher than 30%.

As depicted in FIG. 3, the laser head 32 is disposed at a predetermined distance apart from the surface of the thin film layer 15c of the metal powder 15 formed in the irradiation area Ar1 inside the chamber 10 such that an axis C1 of the laser head is aligned in the vertical direction. However, the present invention is not limited to this, and the laser head 32 may be disposed such that the axis C1 is aligned at a predetermined angle with respect to the vertical direction.

The laser head 32 includes a 3D or 2D galvanometer scanner (not depicted), and can flexibly apply the near-infrared laser beam L1 generated by the laser oscillator 31 onto the surface of the thin film layer 15c at a predetermined position, utilizing functions of the galvanometer scanner controlled by the shaping controller 28. Using the 3D or 2D galvanometer scanner is a well-known technique, and thus detailed description thereof is omitted.

The predetermined position at which the near-infrared laser beam L1 is applied will be described in detail later. The near-infrared laser beam L1 emitted from the laser head 32 is applied into the chamber 10 through a transparent glass or resin provided on a top surface of the chamber 10, and reaches the predetermined position on the surface of the thin film layer 15c.

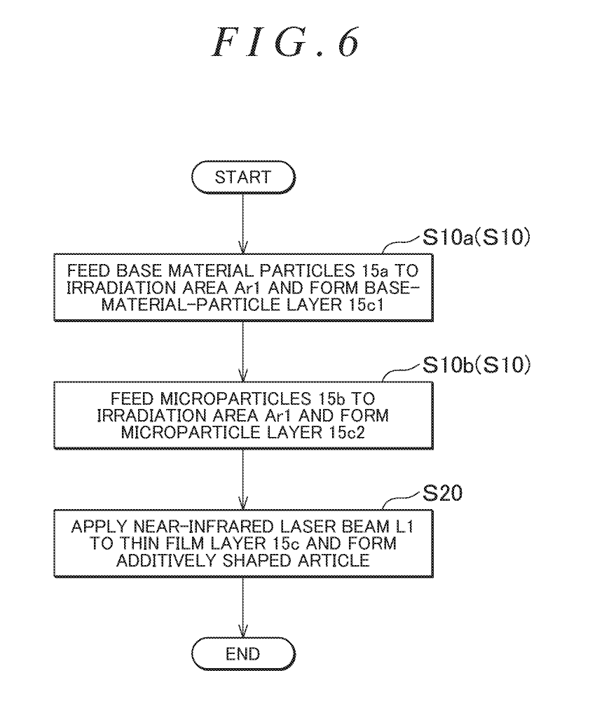

The following describes an additively shaped article manufacturing method with reference to a flowchart in FIG. 6. In the manufacturing method, air inside the chamber 10 is replaced with Ar gas, for example, by a gas replacement device (not depicted). However, description for this process is omitted.

In the base-material-particle storing container 22a constituting the base-material-particle storage 41, the above-described base material particles 15a (aggregate) are charged such that the base-material-particle storing container 22a is filled therewith up to the open end at the top. Inside the microparticle storing container 22b constituting the microparticle storage 42, the above-described microparticles 15b (aggregate) are charged such that the microparticle storing container 22b is filled therewith up to the open end at the top.

The additively shaped article manufacturing method includes a first step S10 and a second step S20. The first step S10 is a step of feeding the base material particles 15a and the microparticles 15b to the irradiation area Ar1 on the shaped-article lifting table 23. The base material particles 15a and the microparticles 15b form the above-described thin film layer 15c (the base-material-particle layer 15c1 and the microparticle layer 15c2) of the metal powder 15. Details will be described later.

Although not depicted, actually, the uppermost surface of the shaped-article lifting table 23 forming the irradiation area Ar1 is positioned below the open end (upper end surface) of the shaping container 21 by a predetermined length, whereby a recess is formed between inner side surfaces of the shaping container 21 and the uppermost surface of the shaped-article lifting table 23. The predetermined length herein is a height that is equivalent to one layer of the base-material-particle layer 15c1 constituting the thin film layer 15c of the metal powder 15.

Herein, if part of the thin film layer 15c (the base-material-particle layer 15c1 and the microparticle layer 15c2) has already been solidified and stacked on the shaped-article lifting table 23, the uppermost surface of the shaped-article lifting table 23 means an uppermost surface of the thin film layer 15c that has already been stacked thereon. FIG. 3 illustrates a state in which the thin film layer 15c part of which has been solidified is stacked in plurality on the shaped-article lifting table 23. The solidified part herein means part of a desired additively shaped article that has been irradiated with the near-infrared laser beam L1 and then solidified.

The following describes the first step S10. As described above, the first step S10 is a step of feeding, to the irradiation area Ar1 of the near-infrared laser beam L1 (shaping optical beam), a plurality of base material particles 15a constituting the metal powder 15 and a plurality of microparticles 15b formed of a metal (copper) identical in type to the base material particles 15a and having an average volume V2 smaller than the average volume V1 of the base material particles 15a.

Specifically, the first step S10 includes a base-material-particle feeding step S10a and a microparticle feeding step S10b. The base-material-particle feeding step S10a depicted in FIG. 6 is a step of feeding the base-material-particle layer 15c1 to the irradiation area Ar1. At the base-material-particle feeding step S 10a, controlled by the metal-powder feeding controller 25, the base-material-particle feeding table 24 is lifted by a predetermined length. Accordingly, some of the base material particles 15a stored in the base-material-particle storage 41 are caused to protrude from the open end (upper end surface) of the base-material-particle storing container 22a. The predetermined length herein is, for example, a value that is slightly greater than the average particle diameter ϕD1 of the base material particles 15a.

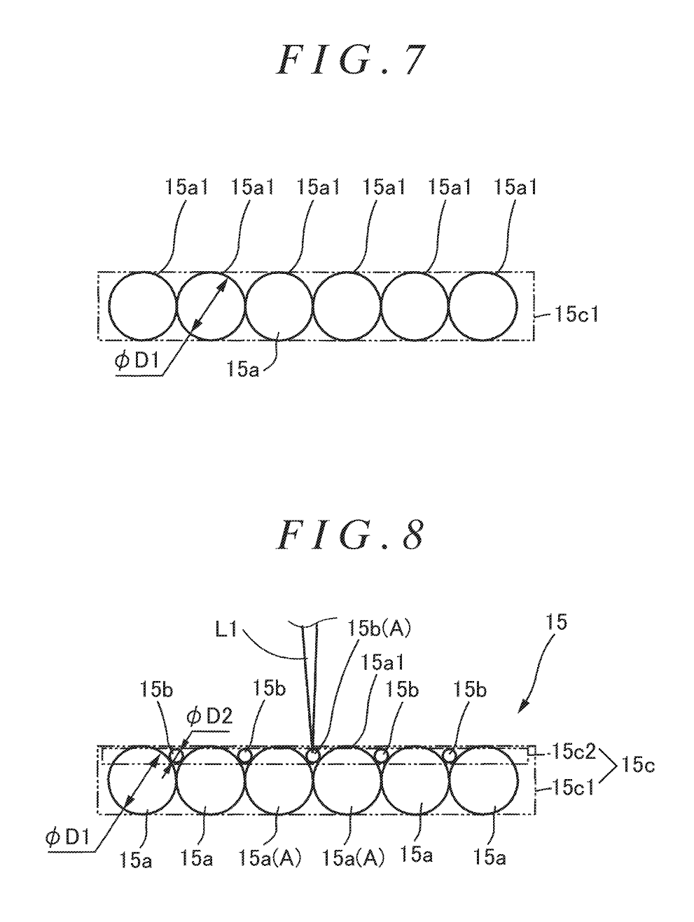

Subsequently, controlled by the metal-powder feeding controller 25, the recoater 26 is moved from right to left in FIG. 3 and FIG. 4, whereby a plurality of base material particles 15a protruding from the open end (upper end surface) of the base-material-particle storing container 22a are conveyed onto the uppermost surface of the shaped-article lifting table 23, and the base material particles 15a are spread all over the irradiation area Ar1 in the recess to form the base-material-particle layer 15c1. In the present embodiment, the depth of the recess herein is slightly greater than the average particle diameter ϕD1 of the base material particles 15a. This allows the base material particles 15a having an average particle diameter ϕD1 to be spread over into the recess one after another as depicted in FIG. 7.

Subsequently, the recoater 26, after passing over the recess from right to left, passes over the microparticle storing container 22b from right to left. At this time, the microparticle storing container 22b is filled with a plurality of microparticles 15b (aggregate) up to the open end (upper end surface) at the top of the microparticle storing container 22b, but the microparticles 15b do not protrude upward from the open end. Thus, even if the recoater 26 passes over the microparticle storing container 22b while conveying surplus base material particles 15a, the base material particles 15a will favorably pass over a plurality of microparticles 15b in the microparticle storing container 22b and be conveyed to the left side of the microparticle storing container 22b. The recoater 26 will not scrape any microparticles 15b in the microparticle storing container 22b.

At the microparticle feeding step S10b, the recoater 26 is moved from left to right in FIG. 3 and FIG. 4, whereby the microparticle layer 15c2 is fed to the irradiation area Ar1. For this process, to begin with, the microparticle feeding table 27 is controlled by the metal-powder feeding controller 25 to be lifted by a predetermined length. Accordingly, some of the microparticles 15b stored in the microparticle storage 42 are caused to protrude from the open end (upper end surface) of the microparticle storing container 22b. The predetermined length of lifting herein is, for example, a value that is slightly greater than the average particle diameter ϕD2 of the microparticles 15b.

At this time, controlled by the metal-powder feeding controller 25, the uppermost surface of the shaped-article lifting table 23 is lowered by a predetermined length from the open end (upper end surface) of the shaping container 21. The predetermined length herein is a height that is equivalent to one layer of the microparticle layer 15c2 constituting the thin film layer 15c. In other words, the predetermined length is a height that is slightly greater than the average particle diameter ϕD2 of the microparticles 15b.

In this state, the recoater 26 is controlled by the metal-powder feeding controller 25 to be moved from left to right in FIG. 3 and FIG. 4. Accordingly, the metal-powder feeding controller 25 causes a plurality of microparticles 15b protruding from the open end (upper end surface) of the microparticle storing container 22b to be conveyed into the recess formed by the uppermost surface of the shaped-article lifting table 23, and to be arranged on upper surfaces in the base-material-particle layer 15c1 spread in the recess (irradiation area Ar1) at the base-material-particle feeding step S10a (see FIG. 5).

In other words, in the irradiation area Ar1, the microparticles 15b are arranged so as to be in contact with respective irradiated surfaces 15a1 that are respective surfaces of the base material particles 15a on a side to be irradiated with the shaping optical beam L1 (upper side in FIG. 5), thereby forming the microparticle layer 15c2 (thin film layer 15c). At this time, the microparticles 15b are arranged stably in hollows that are formed on the irradiated surfaces 15a1 side in the base-material-particle layer 15c1 spread in the irradiation area Ar1 as depicted in FIG. 5.

The following describes the second step S20. At the second step S20, controlled by the shaping controller 28 included in the shaping-optical-beam irradiation device 30, the laser oscillator 31 is activated. Onto a surface of the thin film layer 15c (the base-material-particle layer 15c1 and the microparticle layer 15c2) fed to the irradiation area Ar1, at a predetermined position thereon, the near-infrared laser beam L1 (shaping optical beam) is applied. The predetermined position is preferred to be a position where the microparticles 15b are arranged in the thin film layer 15c. Note that the predetermined position is a position that is based on sliced data (rendered pattern) of an additively shaped article to be produced, and is a position where the additively shaped article is intended to be formed.

Thus, both cases need to be considered that are a case when the near-infrared laser beam L1 is applied to the microparticles 15b and a case when the near-infrared laser beam L1 is applied to the irradiated surfaces 15a1 of the base material particles 15a. Each of the cases will be described.

The following describes first the case when the near-infrared laser beam L1 is applied to the microparticles 15b in the irradiation area Ar1. As depicted in FIG. 8, when the near-infrared laser beam L1 is applied to a microparticle 15b(A) in the thin film layer 15c, the microparticle 15b(A) having a small average particle diameter ϕD2 and a small heat capacity rises in temperature faster than the case when the near-infrared laser beam L1 is applied to a base material particle 15a having a large average particle diameter ϕD1 and a large heat capacity. Thus, the microparticle 15b(A) the temperature of which has risen heats and maintains the heat of base material particles 15a(A) that are in contact therewith. When the microparticle 15b changes from a solid state into a liquid state, the absorptance of the near-infrared laser beam L1 rapidly increases. Accordingly, the microparticle 15b(A) absorbs a greater amount of the near-infrared laser beam L1 to rise in temperature, and further heats the base material particles 15a(A) that are in contact therewith. Consequently, the base material particles 15a(A) also are melted in a short period of time similarly to the microparticle 15b(A).

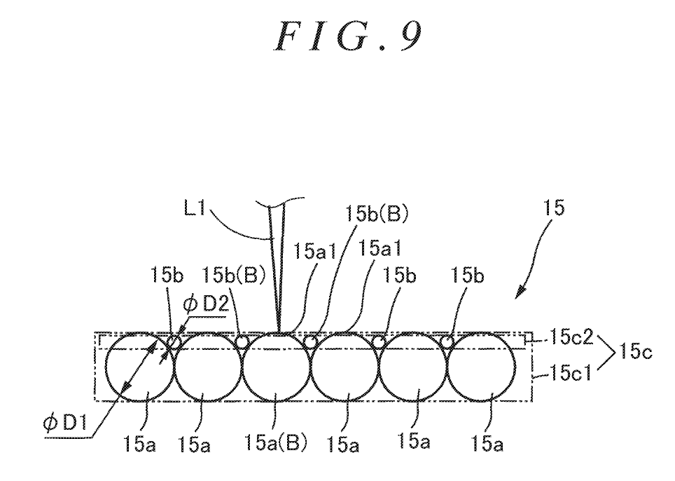

The following describes the case when the near-infrared laser beam L1 is applied to the irradiated surfaces 15a1 of the base material particles 15a in the irradiation area Ar1. As depicted in FIG. 9, when the near-infrared laser beam L1 is applied to the irradiated surface 15a1 of a base material particle 15a(B) in the thin film layer 15c, the temperature of the base material particle 15a(B) slowly rises because the absorptance of the near-infrared laser beam L1 therein is low. However, the temperature that has slightly risen by absorbing the near-infrared laser beam L1 raises the temperature of microparticles 15b(B) that are in contact with the base material particle 15a(B). Accordingly, the microparticles 15b(B) the temperature of which has risen serve as heat reserving materials for the base material particle 15a(B) that is in contact therewith, thereby being able to accelerate temperature rise of the base material particle 15a(B) irradiated with the near-infrared laser beam L1. In this manner, also in the case when the near-infrared laser beam L1 is applied to the irradiated surface 15a1 of the base material particle 15a(B), melting time of the base material particle 15a can be shortened by exchanging heat with the microparticles 15b(B).

Subsequently, by cooling the base material particles 15a and the microparticles 15b that have melted in a short period of time, a solidified thin film layer having high strength is formed. Herein, as described above, in the present embodiment, the base material particles 15a and the microparticles 15b are formed such that the ratio of the average particle diameter ϕD2 of the microparticles 15b each formed in a spherical shape to the average particle diameter ϕD1 of the base material particles 15a each formed in a spherical shape becomes ⅙(=ϕD2/ϕD1). Because of this ratio among conditions in FIG. 2, the base material particles 15a are quickly melted and then solidified, and the relative density of a portion thus solidified in the thin film layer 15c is increased. By repeating such melting and solidification, the solidified portion having a high relative density is stacked on one after another, whereby an additively shaped article having high strength is formed.

In the above-described process, after the additively shaped article is completed, metal powder 15 (a plurality of base material particles 15a and a plurality of microparticles 15b) that has not been solidified, that is, remaining metal powder remains around the additively shaped article. This remaining metal powder can be separated by filtration with a filter into a plurality of base material particles 15a and a plurality of microparticles 15b to be recycled, which is efficient.

In the first embodiment described above, a plurality of base material particles 15a and a plurality of microparticles 15b are each formed in a spherical shape. The base material particles 15a and the microparticles 15b are formed such that the ratio of the average particle diameter ϕD2 of the microparticles 15b each formed in a spherical shape to the average particle diameter ϕD1 of the base material particles 15a each formed in a spherical shape becomes ⅙(=ϕD2/ϕD1), for example. However, the present invention is not limited to this. The base material particles 15a and the microparticles 15b may each be formed in a shape other than the spherical shape.

In this case, because each microparticle 15b does not have a spherical shape, instead of using the average particle diameters, the base material particles 15a and the microparticles 15b are formed such that the ratio of the average volume V2 of the microparticles 15b to the average volume V1 of the base material particles 15a becomes equal to or smaller than 6.4%. In this way, effects similar to those in the above-described embodiment can be obtained, and thus the present invention can be used for non-spherical powder generated by an inexpensive water atomization, for example.

In the embodiment, the base material particles 15a and the microparticles 15b are stored in separate storages 40 (the base-material-particle storage 41 and the microparticle storage 42), and are each fed by the metal-powder feeding device 20 to the irradiation area Ar1 to form metal powder 15 therein. However, the present invention is not limited to this. Before being fed to the irradiation area Ar1, the base material particles 15a with a plurality of microparticles 15b attached on their outer peripheral surfaces may be stored in one storage 40. In this case, when the microparticles 15b attached on the entire perimeter of each base material particle 15a are fed to the irradiation area Ar1, some of the attached microparticles 15b are arranged so as to be in contact with respective irradiated surfaces that are respective surfaces of the base material particles on a side to be irradiated with the near-infrared laser beam L1 (shaping optical beam). Thus, effects similar to those of the embodiment can be obtained.

The embodiment has been described in which copper is used as a material of the metal powder 15. However, the present invention is not limited to this, and aluminum may be used instead. In this case also, effects similar to those of the embodiment can be obtained.

The present invention is not limited to the aspect of the embodiment, and when the base material particles 15a and the microparticles 15b are fed to the irradiation area Ar1, the base material particles 15a and the microparticles 15b may be dropped from above to be fed to near the recoater 26, and the respective fed particles may be conveyed to the irradiation area Ar1 by operation of the recoater 26. In this case, the structure of the storages 40 (the base-material-particle storage 41 and the microparticle storage 42) is different from that in the present embodiment. In this case also, similar effects can be obtained.

As is clear from the above, in the manufacturing method according to the embodiment, at the first step S10 (S10a and S10b), the microparticles 15b having an average volume V2 smaller than that of the base material particles 15a are fed to the irradiation area Ar1 so as to be arranged to be in contact with the irradiated surfaces 15a1 of the base material particles 15a. At the second step S20, when the near-infrared laser beam L1 (shaping optical beam) is applied to the microparticles 15b, the temperature of the respective microparticles 15b having a smaller heat capacity because of the smaller average volume V2 rises faster than the temperature rising speed of the base material particles 15a having a larger average volume V1 when the near-infrared laser beam L1 is applied to the base material particles 15a, and accordingly the microparticles 15b are quickly melted into a liquid state.

Thus, the absorptance of the near-infrared laser beam L1 (shaping optical beam) in the melted microparticles 15b becomes higher than when the microparticles are in a solid state, and the temperature thereof rises at a more favorable speed. At this time, the melted microparticles 15b the temperature of which has risen heat and maintain the heat of the base material particles 15a that are in contact with the microparticles 15b at the irradiated surfaces 15a1, thereby increasing the absorptance of the near-infrared laser beam L1 (shaping optical beam) in the base material particles 15a. Thus, when the near-infrared laser beam L1 is applied to the base material particles 15a directly or via the melted microparticles 15b, the near-infrared laser beam L1 is favorably absorbed by the base material particles 15a, whereby the base material particles 15a can be melted in a short period of time. Herein, because the microparticles 15b and the base material particles 15a are formed of the same type of metal, the melted metal will not be contaminated with impurities. Under these conditions, an additively shaped article having high relative density and high strength can be stably manufactured.

In the manufacturing method according to the embodiment, the first step S10 includes the base-material-particle feeding step S10a and the microparticle feeding step S10b. At the base-material-particle feeding step S10a, the base material particles 15a are fed to the irradiation area Ar1 of the near-infrared laser beam L1 (shaping optical beam). At the microparticle feeding step S10b, the microparticles 15b are fed so as to be arranged to be in contact with the respective irradiated surfaces of the base material particles 15a fed to the irradiation area Ar1 at the base-material-particle feeding step S10a. In this manner, the base material particles 15a and the microparticles 15b are separately fed to the irradiation area Ar1, which reliably enables a positional relation between the base material particles 15a and the microparticles 15b to be in a desired state, and consequently an additively shaped article having high density and high strength can be manufactured.

In the manufacturing method according to the embodiment, the base material particles 15a and the microparticles 15b each have a spherical shape, and the ratio of the average particle diameter ϕD2 of the microparticles 15b to the average particle diameter ϕD1 of the base material particles 15a is equal to or smaller than ⅖. Because the base material particles 15a and the microparticles 15b have such a relation, based on the graph of FIG. 2, the microparticles 15b and the base material particles 15a can be melted in a short period of time, whereby an additively shaped article having high density and high strength can be stably manufactured.

In the manufacturing method according to the embodiment, the ratio of the average volume V2 of the microparticles 15b to the average volume V1 of the base material particles 15a is equal to or smaller than 6.4%. This ratio is equivalent to a ratio (ϕD2/ϕD1) of ⅖ or smaller when the average volumes are converted to the average particle diameters ϕD1 and ϕD2 of the base material particles 15a and the microparticles 15b in the first embodiment. By this setting, the microparticles 15b and the base material particles 15a can be melted in a short period of time, whereby an additively shaped article having high density and high strength can be stably manufactured.

In the manufacturing method according to the embodiment, the near-infrared laser beam L1 (shaping optical beam) is a laser beam of a near-infrared wavelength, and the metal powder is formed of copper or aluminum. Copper or aluminum is a material that has a very low absorptance for a laser beam of a near-infrared wavelength at room temperature. Thus, in the manufacturing method according to the embodiment, greater effects can be expected than those of when a different metal having a high absorptance for a laser beam of a near-infrared wavelength is used from the start of manufacturing.

With the manufacturing apparatus according to the embodiment, an additively shaped article having high relative density and high strength, which is equivalent to the additively shaped article manufactured by the manufacturing method according to the embodiment, can be stably manufactured.

What is claimed is:

1. An additively shaped article manufacturing method of additively shaping an article by melting metal powder through irradiation with a shaping optical beam and then solidifying the melted metal powder, the manufacturing method comprising:
a first step of feeding a plurality of base material particles and a plurality of microparticles both constituting the metal powder to an irradiation area of the shaping optical beam, the microparticles formed of a metal identical in type to the base material particles and having an average volume smaller than the average volume of the base material particles; and
a second step of applying the shaping optical beam to the microparticles fed to the irradiation area at the first step and respective irradiated surfaces that are respective surfaces on a side to be irradiated with the shaping optical beam among respective surfaces of the base material particles fed to the irradiation area at the first step, wherein
the microparticles fed to the irradiation area at the first step are arranged so as to be in contact with the respective irradiated surfaces of the base material particles.

2. The additively shaped article manufacturing method according to claim 1, wherein
the first step comprises:
a base-material-particle feeding step of feeding the base material particles to the irradiation area of the shaping optical beam; and
a microparticle feeding step of feeding the microparticles such that the microparticles are arranged to be in contact with the respective irradiated surfaces of the base material particles fed to the irradiation area at the base-material-particle feeding step.

3. The additively shaped article manufacturing method according to claim 1, wherein
the base material particles and the microparticles each have a spherical shape, and a ratio of an average particle diameter of the microparticles to the average particle diameter of the base material particles is equal to or smaller than ⅖.

4. The additively shaped article manufacturing method according to claim 1, wherein
a ratio of the average volume of the microparticles to the average volume of the base material particles is equal to or smaller than 6.4%.

5. The additively shaped article manufacturing method according to claim 1, wherein
the shaping optical beam is a laser beam of a near-infrared wavelength, and
the metal powder is formed of copper or aluminum.

6. The additively shaped article manufacturing method according to claim 2, wherein
out of the metal powder fed to the irradiation area, remaining metal powder that remains without being melted by irradiation with the shaping optical beam is separated by a filter into the base material particles and the microparticles.

7. An additively shaped article manufacturing apparatus that additionally shapes an article by melting metal powder through irradiation with a shaping optical beam and then solidifying the melted metal powder, the manufacturing apparatus comprising:
a chamber capable of isolating inside air from outside air;
a storage that stores a plurality of base material particles and a plurality of microparticles both constituting the metal powder, the microparticles formed of a metal identical in type to the base material particles and having an average volume smaller than the average volume of the base material particles;
a metal-powder feeding device that is provided inside the chamber and feeds the base material particles and the microparticles stored in the storage to an irradiation area of the shaping optical beam; and
a shaping-optical-beam irradiation device that applies the shaping optical beam to the microparticles fed to the irradiation area and respective irradiated surfaces that are respective surfaces on a side to be irradiated with the shaping optical beam among respective surfaces of the base material particles fed to the irradiation area, wherein
in the irradiation area, the microparticles are arranged so as to be in contact with the respective irradiated surfaces of the base material particles.

8. The additively shaped article manufacturing apparatus according to claim 7, wherein
the storage comprises:
a base-material-particle storage that stores the base material particles yet to be fed to the irradiation area; and
a microparticle storage that stores the microparticles yet to be fed to the irradiation area, and
the metal-powder feeding device feeds
the base material particles stored in the base-material-particle storage, and
the microparticles stored in the microparticle storage
to the irradiation area such that the microparticles are arranged to be in contact with the respective irradiated surfaces of the base material particles, and
the shaping-optical-beam irradiation device applies the shaping optical beam to the respective irradiated surfaces of the base material particles and the microparticles fed to the irradiation area.

9. The additively shaped article manufacturing apparatus according to claim 7, wherein
the base material particles and the microparticles each have a spherical shape, and a ratio of an average particle diameter of the microparticles to the average particle diameter of the base material particles is equal to or smaller than ⅖.

10. The additively shaped article manufacturing apparatus according to claim 7, wherein
a ratio of the average volume of the microparticles to the average volume of the base material particles is equal to or smaller than 6.4%.

11. The additively shaped article manufacturing apparatus according to claim 7, wherein
the shaping optical beam is a laser beam of a near-infrared wavelength, and
the metal powder is formed of copper or aluminum.

12. The additively shaped article manufacturing apparatus according to claim 8, wherein
out of the metal powder fed to the irradiation area, remaining metal powder that remains without being melted by irradiation with the shaping optical beam is separated by a filter into the base material particles and the microparticles.
